(19) United States
(12) Patent Application Publication
(10) Pub. No.: US 2009/0312092 A1
(43) Pub. Date: Dec. 17, 2009

(54) GAMING METHOD, GAMING SYSTEM AND GAME CONTROLLER

(75) Inventor: Oliver Boyd Errington, Newport (AU)

Correspondence Address: HANLEY, FLIGHT & ZIMMERMAN, LLC, 150 S. WACKER DRIVE, SUITE 2100, CHICAGO, IL, 60606, US

(73) Assignee: Aristocrat Technologies Australia PTY Limited, North Ryde (AU)

(21) Appl. No.: 12/485,660

(22) Filed: Jun. 16, 2009

(30) Foreign Application Priority Data
Jun. 16, 2008 (AU) 2008903058

(51) Int. Cl. A63F 9/24; G06F 19/00

(52) U.S. Cl. 463/25; 463/40; 463/29

(57) ABSTRACT

A gaming method comprising the steps of: nominating using a player's communication device a set of items; providing set data defining the set of items to a game controller via a communication network; selecting by the game controller a subset of a given subset size based on the set data using a random result generation process; and providing subset selection information to at least the player's communication device via the communication network.

### CROSS-REFERENCE TO RELATED APPLICATIONS

The present application claims the benefit of priority to Australian Provisional Patent Application No. 2008903058, filed on Jun. 16, 2008, entitled “GAMING METHOD, GAMING SYSTEM AND GAME CONTROLLER”, which is herein incorporated by reference in its entirety.

### FIELD OF THE INVENTION

The field of the invention is gaming systems and methods whereby players access a game controller via a communication network. An example of an application of an embodiment is a game played using a person's mobile phone as a player interface.

### BACKGROUND OF THE INVENTION

Game controllers employing random result generators, such as random number generators or pseudo-random number generators, to generate game outcomes are known. Known gaming systems can include a game controller for controlling game play and one or more player interfaces. Player interfaces are used by players to enter game play instructions and receive game outcomes. In some known gaming systems player interfaces are connected to the game controller via a communication network.

There is a need for alternative games, systems and methods utilizing communication network accessible game controllers.

### SUMMARY OF THE INVENTION

According to one aspect there is provided a gaming method including the steps of:

nominating using a player's communication device a set of items;

providing set data defining the set of items to a game controller via a communication network;

selecting by the game controller a subset of a given subset size based on the set data using a random result generation process; and

providing subset selection information to at least the player's communication device via the communication network.

In an embodiment the given subset size can be nominated by the player. The given subset size can be provided to the game controller with the set data.

The player's communication device can be a mobile phone, personal digital assistant, palmtop computer or the like adapted to communicate with a game controller via a wireless communication network.

In an embodiment, nominating the set of items includes inputting item information into the communication device.

In an embodiment items of the nominated set are names selected from a contact list stored in memory accessible by the player's communication device. In this embodiment, the set data provided to the game controller can include device identification data associated with each name, whereby subset selection information can also be provided to the device associated with one or more names in the set.

In some embodiments, providing subset selection information includes providing instructions for playing an animation representing the selection on the player's communication device.

In an embodiment providing subset selection information can further include providing instructions for playing an animation to one or more communication device's, each associated with a respective name from the set data.

An embodiment of the method further includes the step of debiting payment for playing the selection game. Debiting payment can include deducting a credit value from a player account. The deducted credit value can be based on the number of devices to which the subset selection information is provided.

In an embodiment the random result generation involves plural steps, each communicated to the player.

According to another aspect there is provided a system for playing a selection game, the system including:

a network module connectable to a communication network;

a random result generator; and

a game controller processor in data communication with the network module and random result generator,

wherein the network module is adapted to receive via the network from a player's communication device, game play instructions including set data for a set of items and provide the set data to the game controller processor, and,

wherein the game controller processor is adapted to, in response to receiving set data, trigger the random result generator to generate a random result, select a subset of a given subset size from the set based on a generated random result, and cause the network module to provide the subset selection information to at least the player's communication device.

An embodiment of the system further includes:

a subscriber register adapted to store player data for one or more players registered to play the selection game, wherein the player data for each player includes player access data and player credit account data; and

an authorisation module adapted to allow registered players to play the selection game based on player access data and debit a given credit value from a player credit account for playing the game.

The subscriber register can be adapted to store one or more applications for downloading to a subscriber's communication device, wherein the application includes a set of instructions executable by a processor of the subscriber's communication device to, in response to player input, prepare set data from information stored in memory accessible by the processor or entered into the communication device. The application can be adapted to prepare set data based on a contact list stored in memory accessible by the communication device.

In an embodiment the application includes data and instructions adapted to cause the communication device processor to play on a communication device display an animation based on subset selection information received from the game controller.

According to another aspect there is provided a game controller processor adapted to:

receive set data for a set of items, from a player's communication device via a communication network;

selectively trigger generation of at least one random result;

select a subset of a given subset size based on the generated random result; and

provide the subset selection information to at least the player's communication device via the communication network.

According to another aspect there is provided computer program code including a set of instructions which, when executed by a computer processor, cause the computer to implement functions of a game controller adapted to:

receive set data for a set of items, from a player's communication device via a communication network;

selectively generate at least one random result;

select a subset of a given subset size based on a generated random result; and

provide subset selection information to at least the player's communication device via the communication network.

### BRIEF DESCRIPTION OF THE DRAWINGS

Certain embodiments will now be described by way of example only with reference to the accompanying drawings in which:

FIG. 1 illustrates an example of a system for playing a selection game via a communication network.

FIG. 2 shows block diagram illustrating an example of a selection game system and user device for playing a selection game via a communication network.

FIG. 3 is a flowchart illustrating an example of a selection game play process.

FIG. 4a is a flowchart illustrating one example of a subset selection process.

FIG. 4b is a flowchart illustrating another example of a subset selection process.

FIG. 4c illustrates mapping a random result to a set of items in accordance with an example of subset selection as given in FIG. 4b.

FIGS. 5a, 5b and 5c illustrate an example of an animation used for presenting subset selection information on a user device.

Features, further aspects, and advantages of the present invention will become apparent from the following description of embodiments thereof, by way of example only, with reference to the accompanying drawings. Also, various embodiments of the aspects described in the preceding paragraphs will be apparent from the appended claims, the following description and/or the accompanying drawings. It should be understood, however, that the present invention is not limited to the arrangements and instrumentality shown in the attached drawings.

### DETAILED DESCRIPTION

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements is hereby expressly defined to include a tangible medium such as a memory, DVD, CD, etc. storing the software and/or firmware.

Embodiments provide a gaming system and method for a selection game played across a communication network.

The game is played by a player, using their communication device, nominating a set of items and providing set data defining the set of items to a game controller via a communication network. A game controller selects a subset of a given subset size based on the set data using a random result generation process, and provides subset selection information to at least the player's communication device via the communication network.

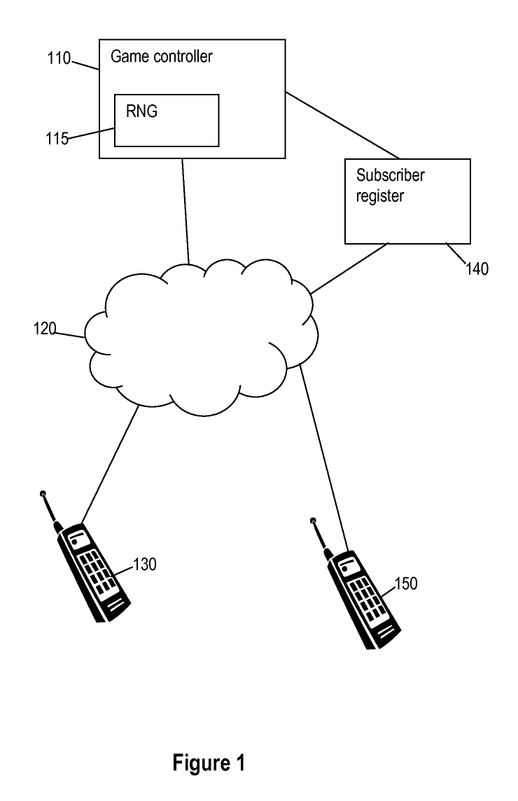

In an embodiment, illustrated in FIG. 1, the selection game is played using a game controller 110 accessible via a communication network 120 from a player's network connected communication device 130, such as a mobile phone, personal digital assistant, palmtop computer or the like.

A player nominates a set of a plurality of items for the selection game and the number of items to be selected from the set using their communication device 130. Set data is provided to the game controller 110 via the communication network 120. The game controller 120 selects a subset of items from the set using a random result generation process. The subset selection information is then returned to the player's communication device 130 via the communication network 120.

The player controls the set of items used for the selection game. In an embodiment the set of items can be a group of names selected from a contact list stored in memory accessible by the player's mobile phone, for example in phone memory or SIM card memory. For example, the player may select names one by one or select a designated group, such as a sports team specified as group in the contact list. In this embodiment set data provided to the game controller may include device identification data, for example contact information, and subset selection information provided to a communication device 150 in addition to the player's device 130 using the device identification data.

A software application may be provided for execution on the player's communication device to assist with set nomination, sending set data to the game controller, and display of the selected subset. The software application can be a set of instructions executable by a communication device processor. The software application may be downloadable from a server and stored in communication device memory. The software application may also include data and instructions for an animation for representation of the selected subset information in an entertaining manner. The selection game provides an entertaining way to obtain an impartial selection from a nominated list, impartiality is ensured by the selection being performed by the game controller based on a random result.

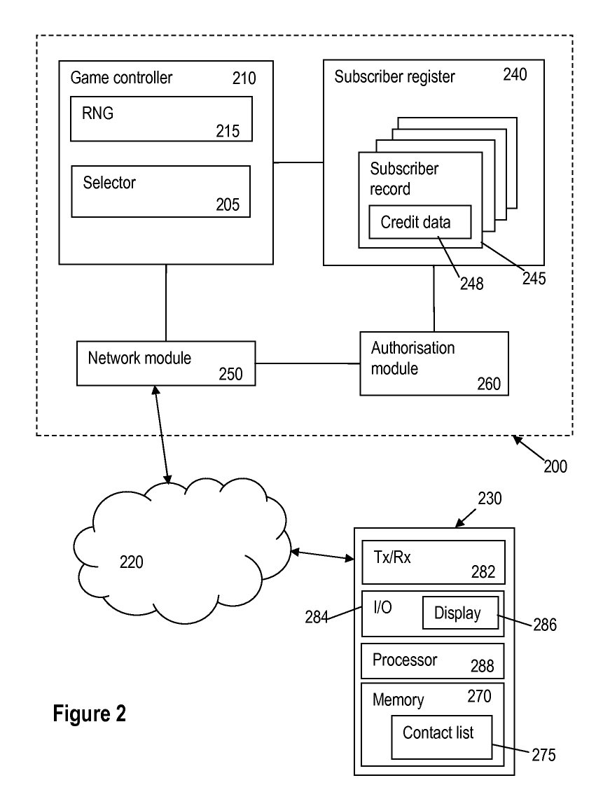

An embodiment of a system for implementing the selection game is illustrated in FIG. 2. The system 200 includes a game controller 210, a random result generator 215, and a network module 250.

The game controller 210 is any device adapted to control game play and can include any suitable combination of software, hardware and firmware to process game play instructions in accordance with game play rules. In the embodiment illustrated the game controller is implemented using a processor. Herein the term “processor” is used to refer generically to any device that can process game play instructions in accordance with game play rules and may include: a microprocessor, microcontroller, programmable logic device or other computational device, a general purpose computer (e.g. a PC) or a server.

The game controller 210 includes sets of instructions to perform the function of a selector 205 and random number generator 215 for generation of random results. A person skilled in the art will appreciate that a reference to a random number generator may also mean a pseudo random number generator. Although the embodiment illustrated in FIG. 2 includes a random number generator implemented in the game controller processor, any type of random result generator in data communication with the game controller may be used. For example, the random result generator 215 may be external to the game controller. A person skilled in the art will understand that the random result generator may 215 be a random number generator, a pseudo-random number generator, or other type of random result generator including a mechanical random result generator such as a dice roller, spinning wheel or card dealer.

The selector function 205 is adapted to select one or more items from a nominated set based on the generated random result. Where more than one item is to be selected from the set, the selector may select more than one item based on one random result, or the selector may use an iterative process, requiring more than one random result to be generated to select the items.

The network module 250 provides the network connectivity functions to access the game controller 210. It should be appreciated that the network module 250 can include any device adapted to provide data connectivity between a network and a processor, examples include but are not limited to modems, servers, Ethernet or other network cards and wireless transceiver devices. The network module 250 is connectable to a communication network 220 such as a telecommunication network or data network for receiving and sending data via the communication network 220.

To play the selection game the player nominates a set of a number of items and optionally a subset size to be selected from the set using a communication device, such as a mobile phone. The subset size may be a default size, for example one, and automatically provided by the device if a size is not nominated by the player. Alternatively, in an embodiment the game controller may be adapted to select a subset of a predetermined given size, such as one item, in this embodiment a subset size would not need to be nominated by the player. Set data and any nominated subset size are provided to the game controller 210 via the communication network 220.

The game controller 210 uses an outcome of a random result generation process to select a subset of a given size from the set. For example, the game controller 210 may, when the set data is received, trigger the random number generator 215 to generate a random number which is applied by the game controller for selecting the subset. Selected subset information is then provided back via the communication network for display on the player's communication device.

The set data provided to the game controller may vary depending on the embodiment implemented. In an embodiment where the set nominated by the player is stored as an itemised list in the player's communication device, the set data provided to the game controller may simply be the number of items in the set. In this embodiment the game controller identifies the selected subset items by their position in the list, for example where the set has ten items and the given subset size is three the game controller may apply a random outcome to select items two, four and seven. This subset information can be provided back to the player's communication device to be used to identify the actual list items including the subset. Alternatively the set data provided may include data specific to each set item each, for example a person's name and contact data.

The network module 250 acts as a network interface for the game controller 210 and can also provide additional functions. In some embodiments the network module may simply implement transport layer and media access functions of a protocol stack leaving all other functions to be performed or controlled by the game controller. However, some embodiments the network module may execute applications and manipulate data as well as providing data to the game controller. For example the network module may provide access control functions and handle connections to additional devices where the selection game outcome is provided to others in addition to the player, for example using contact data provided with the set data.

The system 200 can include optional modules such as a subscriber register 240 and an authorisation module 260. These modules may be implemented independent of the game controller, say using a server and database independent of the game controller, or may be implemented as functions of a server also including the network module 250 and/or game controller 210. A person skilled in the art will appreciate that these modules may be implemented using a variety of architectures and all possible alternatives are contemplated with in the scope of this application.

The subscriber register 240 stores subscriber records 245 for an embodiment where users must subscribe to play the selection game. Subscriber records include subscriber data such as identification data, contact information, preferences etc. In an embodiment where credits are charged to the subscriber each time the game is played, the subscriber record may also store credit data 248 indicating a credit value available for playing the game. The subscriber register 240 may be used for subscription to a suite of services of with the selection game is one service.

The authorisation module 260 can be provided to control access to the selection game. For example, the authorisation module may be used to verify that a player has subscribed to the selection game by looking up the subscriber record before the game play instructions are forwarded to the game controller. The authorisation module may also look up credit data to ensure the player has sufficient credit to play the game, and optionally cause the credit charge for playing the game to be deducted from the stored credit value, before enabling access to the game.

Users can access the selection game via a communication network 220 using a communication device 230, for example from their mobile phone over a telecommunication network and the Internet. An example of a user device 230 suitable for use with the system 200 is illustrated in FIG. 2. The device 230 typically includes a transceiver 280 for transmitting data to and receiving data from the communication network 220, a user input and output interface 284, a processor 288 and memory 270.

The processor 288, is a processing device such as a microprocessor or the like, adapted to control device functions and execute software programs stored in the device memory 270. The processor 288 and memory 270 architecture may vary depending on the type of user device. For example the user device may be a personal computer or laptop computer, mobile phone, personal digital assistant etc. The user input and output interface 284 includes a display 286 and any combination of interfaces in accordance with the style of device, for example keypad, keyboard, microphone, data input and output ports, video capture etc.

A player uses the user interface to nominate a set of items to be used to play the selection game. The set of items may be entered in its entirety using the user interface or be based on information stored in the device memory, memory accessible by the device processor or other connected source. For example, the set of items may be a list of names selected from a contact list 275 stored in the device memory or a SIM card. Alternatively the set may be selected from items listed on another source, such as an Internet web site, say showing a restaurant menu or movie guide, being viewed via the device. Once the set is nominated by the player, the transceiver 282 is used to transmit the set data to the game controller 210 via the communication network 220. Selected subset information, provided from the game controller 210 after selection, is also received via the transceiver 282. The selected subset can then be displayed to the player on the display 286.

A software application may be provided to the device for facilitating the player nominating the set and providing set data to the game controller. The software application can be a set of instructions executable by the device processor. The software application may be installed on the player's communication device for example by downloading from a server or loading onto the device from a storage medium such as a disk or memory card. The application may provide a graphical user interface (GUI) for facilitating set nomination in a user friendly and/or entertaining manner. For example, the application may enable the player to view their contact list on a device display and nominate contacts from the contact list as set items by pressing a SELECT button. The application can read the required information from each selected contact record and prepare the set data for sending to the game controller using this information. The GUI may also be adapted to entertain the player during the selection process and present the selected subset data in an entertaining manner. For example, an animation displayed on the device display may be a spinning reel showing all items of the set and the selection result represented by a stop position of the reel, sounds or tunes may also be played on device speakers to enhance the animation. Such an application may be downloaded to the device when a user subscribes to the selection game play service.

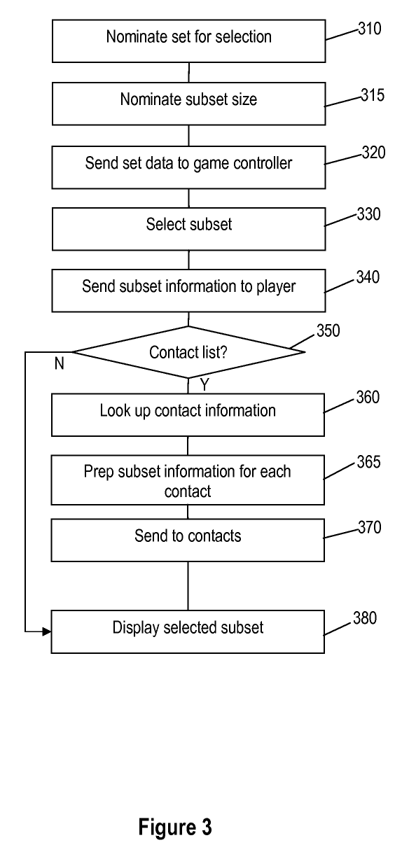

An embodiment of a selection game play process is illustrated in FIG. 3. To start the game a player nominates a set of items for selection 310 using their communication device, for example a mobile phone. The set of items may be nominated in accordance with a question, and the questions may also be entered in to the device and stored. For example, the player may ask the question “Who's house should we watch the football at tomorrow?” and enter this query into their device. The player can then enter the names of the group of friends who plan to watch the football together or select the names of the group from a contact list stored in the device or on the device SIM card. This list becomes the nominated set for selection. The player may optionally nominate the subset size for selection, in this case one. In some embodiments a subset size of one or another value may be a default subset size, chosen if no subset size is nominated. Alternatively the subset size may be fixed for the game controller, in this embodiment no subset size would be nominated by the player.

Once the set of items is nominated, set data is provided to the game controller 320 via the communication network. The set data is used for subset selection 330 by the game controller. The game controller selects the subset based on a random outcome generated by a random result generator, such as a random number generator or the like. The input for the selection process can be the number of items in the set and a given subset size.

The selection may be based on a single random outcome or iteratively generated random outcomes. Where the given subset size is one the subset can be selected based on a single random outcome. Where the subset size is greater than one, the subset may be selected based on a single random result or the subset may be selected iteratively using more than one random outcome.

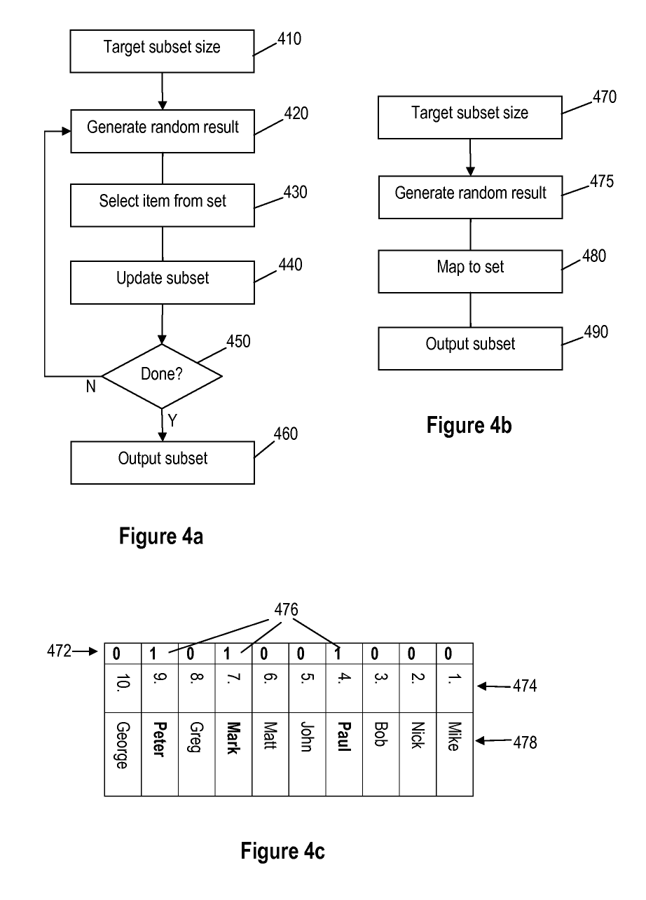

An example of iterative subset selection is illustrated in detail FIG. 4a. In this example, the target subset size 410 is used for an iteration counter. A random result is generated 420 and used to select 430 one item from the set which is then added to the subset 440. If the subset is not of the target size 450 then this process is repeated again to select a further item from the remainder of the set until the subset is of the target size. The subset is then output 460. Alternatively the subset selection may be output iteratively to the player, for example the iterative selection results may be used by an animation to display the subset items being selected one by one in an entertaining manner.

FIGS. 4b and 4c illustrate an example of a subset selection process where a single random outcome is used to select more than one subset item. In this example the set of items is mapped to bit sequence. The target subset size 470 represents the number of “ones” to be included in a bit sequence based on a generated random output 475. For example a generated bit sequence 470 for a set 478 of ten items with a given subset size of three is illustrated in FIG. 4c. The “ones” 476 are mapped 480 to the set items 474 to identify the selected subset. The selected subset can then be output 490. In some embodiments the mapping of the bit sequence to the set to identify the items in the selected subset may be performed in the user device based on the bit sequence output by the game controller.

Subset selection information is sent to the player 340, for example as described above, for display on the player's device 380.

In some embodiments, the system may be adapted to provide the set selection information to communication devices other than the player's device. For example, where the set of items is selected from a contact list stored on the player's communication device, the set data may include contact information for the associated with each name in the set for selection. This contact information can be used for sending subset selection information to devices in addition to the player's device. Whether or not the set selection information is to be sent to other devices can be based on a player instruction. This player instruction may be sent with the set data or be a default instruction, for example stored in a subscriber profile. If contact information is provided 350, it is determined which additional devices are to be sent the subset selection information and the contact information looked up for these devices 360.

The subset information is prepared for sending to each contact 365, this may involve looking up additional information for each contact. For example, each contact may be looked up in a subscriber register to determine whether the contact is a subscriber to the system and has available an application to play an animation to display the subset information, subset information may be provided in a different format for subscribers to other contacts, such as a format adapted to trigger the application on the contact's device to play the animation for contacts who are subscribers and a generic SMS format for contacts who are not subscribers. Where an animation is used for displaying the set selection information additional information for use by the animation may also be sent with the subset selection information. For example, timing data, display sequence, animation theme to use etc. The prepared information is sent to the contacts 370 for display on their devices 380, and can be displayed concurrently with the display of the selected subset on the player's device.

An animation used to display the selection game outcome may be identical or different for each device. For example each device may show the same animation, such as a spinning wheel. Alternatively users may select a preferred theme for the selection game display, for example one may choose a spinning wheel theme and another a spinning coin, and the chosen theme will be used to display the selected subset on each device respectively. The display theme preference may be stored in the device memory or in a subscriber register depending on the system embodiment implemented. Alternatively the a common theme may be used for each device and the manner in which it is displayed varied relatively between devices, for example an animation showing a race to construct a pyramid, with the first second and third places going to the three people in the selected subset.

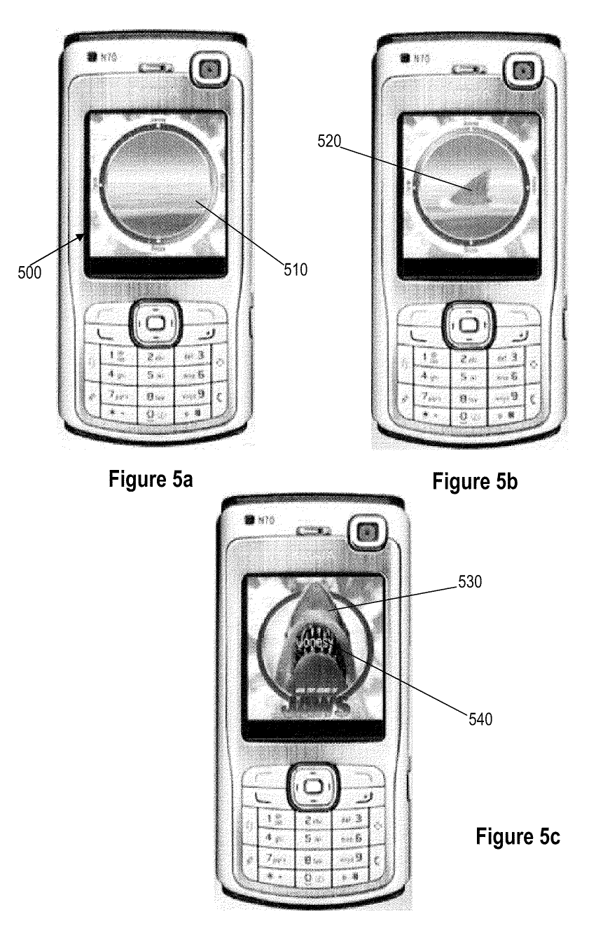

In some embodiments, for devices having an application available for playing an animation for displaying the selection game outcome, animation control instructions may be prepared individually for each device to produce an entertaining effect. For example as illustrated in FIG. 5, the animation, displayed on the device display 500, may include a placid sea surface 510 and a shark which “swims” below the surface, showing its fin 520 above the sea surface periodically and breaks the surface 530 showing the name of the selected person 540 in its jaws to illustrate the outcome of the selection game.

Where the selected subset is sent to more than one device for display, the timing for when the frames of the animation showing the shark fin are displayed on each device may be different, relative to each other device, to give the impression that the shark is swimming between the devices. The frames of the shark breaking the surface to show the selection outcome may appear on every device. Such an animation can provide entertainment for the player and members of the selection group while playing the game. A similar effect, of the animation being displayed across multiple devices can be provided using other animations, for example, bouncing balls, a cat chasing mice, fireworks etc. It should be appreciated by the person skilled in the art that many theme variations are possible and all are contemplated within the scope of this application.

In the claims which follow and in the preceding description, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A gaming method comprising the steps of:
nominating using a player's communication device a set of items;
providing set data defining the set of items to a game controller via a communication network;
selecting by the game controller a subset of a given subset size based on the set data using a random result generation process; and
providing subset selection information to at least the player's communication device via the communication network.

2. A method, as claimed in claim 1, wherein the given subset size is nominated by the player.

3. A method, as claimed in claim 2, wherein the given subset size is provided to the game controller with the set data.

4. A method, as claimed in claim 1, wherein the player's communication device is a mobile phone, personal digital assistant, palmtop computer or the like adapted to communicate with a game controller via a wireless communication network.

5. A method, as claimed in claim 1, wherein nominating the set of items includes inputting item information into the communication device.

6. A method, as claimed in claim 4, wherein items of the nominated set are names selected from a contact list stored in memory accessible by the player's communication device.

7. A method, as claimed in claim 6, wherein the set data provided to the game controller includes device identification data associated with each name, whereby subset selection information can also be provided to the device associated with one or more names in the set.

8. A method, as claimed in claim 7, wherein providing subset selection information includes instructions for playing an animation representing the selection on the player's communication device.

9. A method, as claimed in claim 8, wherein providing subset selection information further includes providing instructions for playing an animation to one or more communication device's, each associated with a respective name from the set data.

10. A method, as claimed in claim 1, further comprising the step of debiting payment for playing the selection game.

11. A method, as claimed in claim 10, wherein debiting payment comprises deducting a credit value from a player account.

12. A method, as claimed in claim 11, wherein the deducted credit value is based on the number of devices to which the subset selection information is provided.

13. A method, as claimed in claim 1, wherein the random result generation involves plural steps, each communicated to the player.

14. A system for playing a selection game, the system comprising:
a network module connectable to a communication network;
a random result generator; and
a game controller processor in data communication with the network module and random result generator,
wherein the network module is adapted to receive via the network from a player's communication device, game play instructions including set data for a set of items and provide the set data to the game controller, and
wherein the game controller processor is adapted to, in response to receiving set data, trigger the random result generator to generate a random result, select a subset of a given subset size from the set based on a generated random result, and cause the network module to provide the subset selection information to at least the player's communication device.

15. A system, as claimed in claim 14, wherein the given subset size is nominated by the player.

16. A system, as claimed in claim 15, wherein the given subset size is provided to the game controller with the set data.

17. A system, as claimed in claim 14, wherein set data includes communication device identification data associated with each set item and subset selection information is provided to one or more communication devices in addition to the player's communication device based on the identification data.

18. A system, as claimed in claim 17, wherein the identification data associated with each selected subset item is used to provide selection information to a communication device associated with each selected item.

19. A system, as claimed in claim 14, further comprising:
a subscriber register adapted to store player data for one or more players registered to play the selection game, wherein the player data for each player includes player access data and player credit account data; and
an authorisation module adapted to allow registered players to play the selection game based on player access data and debit a given credit value from a player credit account for playing the game.

20. A system, as claimed in claim 19, wherein the subscriber register is further adapted to store one or more applications for downloading to a subscriber's communication device, wherein the application comprises a set of instructions executable by a processor of the subscriber's communication device to, in response to player input, prepare set data from information stored in memory accessible by the processor or entered into the communication device.

21. A system, as claimed in claim 20, wherein the application is adapted to prepare set data based on a contact list stored in memory accessible by the communication device.

22. A system, as claimed in claim 20, wherein the application includes data and instructions adapted to cause the communication device processor to play on a communication device display an animation based on subset selection information received from the game controller.

23. A game controller processor adapted to:
receive set data for a set of items, from a player's communication device via a communication network;
selectively trigger generation of at least one random result;
select a subset of a given subset size based on the generated random result; and
provide the subset selection information to at least the player's communication device via the communication network.

24. An article of manufacture comprising:
a computer readable storage medium; and
executable program instructions embodied in the computer readable storage medium that when executed by a computer processor cause the processor to perform functions that implement a game controller adapted to:
receive set data for a set of items, from a player's communication device via a communication network;
selectively generate at least one random result;
select a subset of a given subset size based on a generated random result; and
provide subset selection information to at least the player's communication device via the communication network.
